(19) United States
(12) Patent Application Publication
(10) Pub. No.: US 2025/0264169 A1
(43) Pub. Date: Aug. 21, 2025

(54) VACUUM ADAPTER SYSTEM AND METHOD

(71) Applicant: Bonnie FREUDINGER, Greenfield, WI (US)

(72) Inventor: Bonnie FREUDINGER, Greenfield, WI (US)

(21) Appl. No.: 19/053,745

(22) Filed: Feb. 14, 2025

Related U.S. Application Data
(60) Provisional application No. 63/553,982, filed on Feb. 15, 2024.

(51) Int. Cl. F16L 13/00; A47L 7/00; A47L 9/24; B23Q 11/00; F16L 13/10

(52) U.S. Cl. CPC F16L 13/004; A47L 7/0095; A47L 9/242; B23Q 11/0046; F16L 13/103

(57) ABSTRACT

An adapter assembly is disclosed. The adapter assembly includes a tapered tube adapter configured to couple to a vacuum hose and a heat shrink tube formed from a heat shrink material and coupled to the tapered tube adapter. The tapered tube adapter is configured to receive the vacuum hose, and the heat shrink tube is configured to be coupled to an exhaust port of a power tool.

### RELATED APPLICATIONS

This application claims priority under 35 U.S.C. § 119 to U.S. Provisional Patent Application No. 63/553,982, filed Feb. 15, 2024, the entirety of which is hereby incorporated by reference.

### BACKGROUND

Power tools such as saws, sanders, and grinders may be used in home workshops or on commercial construction sites, for example. These power tools tend to generate harmful airborne particulates including fumes, sawdust, lead particles, silica dust, fiberglass particles, and drywall dust, among other things. Woodworkers and contractors routinely attempt to configure a vacuum (e.g., a Shop-Vac) to collect such harmful particulates by attaching the vacuum's hose to an exhaust port of the power tool being used. However, it is difficult to find adapters that facilitate coupling a vacuum hose with the exhaust port of various power tools. This difficulty stems in part from the fact that each power tool has a unique exhaust port geometry. Additionally, in most cases, woodworkers and contractors must frequently change tools while working on a given project. Therefore, there is a need for a vacuum hose adapter that can attach to a wide variety of power tool exhaust ports.

### SUMMARY

In one aspect, an adapter assembly is disclosed. The adapter assembly includes a tapered tube adapter configured to couple to a vacuum hose and a heat shrink tube formed from a heat shrink material and coupled to the tapered tube adapter. The tapered tube adapter is configured to receive the vacuum hose, and the heat shrink tube is configured to be coupled to an exhaust port of a power tool.

In some instances, the heat shrink tube includes a first section configured to be coupled to the exhaust port and a second section coupled to the tapered tube adapter. In some instances, the second section is pre-shrunk around the tapered tube adapter. In some instances, the first section shrinks in response to an application of heat. In some instances, the second section is coupled to the tapered tube adapter by an adhesive. In some instances, the tapered tube adapter includes a first end and a second end. The tapered tube adapter can be defined by a first diameter at the first end and a second diameter at the second end, and the first diameter is larger than the second diameter. In some instances, the tapered tube adapter is configured to receive the vacuum hose in a slip fit. In some instances, the first section has a larger diameter than the second section. In some instances, the heat shrink tube is configured to be interchangeably coupled to a plurality of power tools, each power tool having an exhaust port with a unique diameter dimension.

In another aspect, an adapter assembly is disclosed. The adapter assembly includes a heat shrink tube defined by a first end and a second end, a first opening positioned proximate to the first end, and a tapered tube adapter positioned proximate to the second end and at least partially received within the heat shrink tube. The first opening is configured to receive an exhaust port of a power tool, and the tapered tube adapter is configured to receive a vacuum hose. In some instances, the heat shrink tube is formed from a heat shrink material that shrinks in response to an application of heat. In some instances, the heat shrink tube includes an unshrunk first section proximate to the first end and a pre-shrunk second section proximate to the second end. The second section is coupled to the tapered tube adapter.

In some instances, the second section includes an adhesive that facilitates coupling between the heat shrink tube and the tapered tube adapter. In some instances, the tapered tube adapter includes an adapter first end proximate to the second end of the heat shrink tube and an adapter second end opposing the adapter first end. The tapered tube adapter is defined by a first diameter at the adapter first end and a second diameter at the adapter second end, and the first diameter is larger than the second diameter. In some instances, the tapered tube adapter is positioned to extend into the heat shrink tube from the second end of the heat shrink tube. In some instances, the tapered tube adapter is configured to receive the vacuum hose in a slip fit. In some instances, the tapered tube adapter defines a second opening configured to receive the vacuum hose.

In a further aspect, a method of installing a vacuum adapter is disclosed. The method includes providing an adapter assembly having a tapered tube adapter and a heat shrink tube. The heat shrink tube includes an adhesive at least partially lining an inner surface of the heat shrink tube, a first section, and a second section. The second section at least partially surrounds the tapered tube adapter and is in contact with an outer surface of the tapered tube adapter. The method further includes covering an exhaust port of a power tool with the first section of the heat shrink tube, applying heat to the first section at least until the inner surface of the heat shrink tube is in contact with the exhaust port, and coupling the tapered tube adapter to a vacuum hose.

In some instances, the tapered tube adapter receives the vacuum hose in a slip fit. In some instances, the first section of the heat shrink tube is configured to receive a plurality of different exhaust ports having different sizes.

### BRIEF DESCRIPTION OF THE DRAWINGS

The accompanying drawings, which are incorporated in and form a part of this specification, illustrate embodiments of the disclosure and, together with the description, serve to explain the principles of embodiments of the disclosure:

FIG. 1A is a perspective side view of an adapter assembly as disclosed herein;

FIG. 1B is a perspective bottom view of the adapter assembly of FIG. 1A;

FIG. 1C is a schematic view of the adapter assembly of FIG. 1A;

FIG. 2A is a schematic representations of a first step in a method of installing the adapter assembly of FIG. 1A as disclosed herein;

FIG. 2B is a schematic representations of a second step in a method of installing the adapter assembly of FIG. 1A as disclosed herein;

FIG. 2C is a schematic representation of a third step in the method of installing the adapter assembly of FIG. 1A as disclosed herein;

FIG. 2D is a schematic representation of a fourth step in the method of installing the adapter assembly of FIG. 1A as disclosed herein;

FIG. 3 is a perspective view of the adapter assembly of FIG. 1A after performing the third step of FIG. 2C;

FIG. 4 is a perspective view of an installed adapter after performing the fourth step of FIG. 2D;

While the disclosure is subject to various modifications and alternative forms, a specific embodiment thereof is shown by way of example in the drawings and will herein be described in detail. It should be understood, however, that the drawings and detailed description presented herein are not intended to limit the disclosure to the particular embodiment disclosed. To the contrary, the intention is to cover all modifications, equivalents, and alternatives falling within the spirit and scope of the present disclosure as defined by the appended claims.

### DETAILED DESCRIPTION

The following description is presented to enable a person skilled in the art to make and use embodiments of the disclosure. Various modifications to the illustrated embodiments will be readily apparent to those skilled in the art, and the generic principles herein can be applied to other embodiments and applications without departing from embodiments of the disclosure. Before any embodiments are described in detail, it is to be understood that the disclosure is not limited in its application to the details of construction and the arrangement of components set forth in the following description or illustrated in the following drawings, which is limited only by the claims that follow the present disclosure. The disclosure is capable of other embodiments and of being practiced or of being carried out in various ways.

It is to be understood that the phraseology and terminology used herein are for the purpose of description and should not be regarded as limiting. The use of “including,” “comprising,” or “having” and variations thereof herein is meant to encompass the items listed thereafter and equivalents thereof, as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

As used herein, unless otherwise specified or limited, “at least one of A, B, and C,” and similar other phrases, are meant to indicate A, or B, or C, or any combination of A, B, and/or C. As such, this phrase, and similar other phrases can include single or multiple instances of A, B, and/or C, and, in the case that any of A, B, and/or C indicates a category of elements, single or multiple instances of any of the elements of the categories A, B, and/or C.

The present disclosure is directed to an adapter assembly for coupling an exhaust port of a power tool to a hose of a vacuum device such that the vacuum device may collect particulate matter ejected via the exhaust port of the power tool and prevent such particulate matter from entering the surrounding environment. In general, the adapter assembly may have a first opening at one end and a second opening at another end. One of the first and second openings may be configured to receive the exhaust port of a power tool, and the other of the first and second openings may be configured to receive a vacuum hose. The exemplary embodiments of the present invention described below with reference to the figures may be configured to be compatible with an exhaust port and a vacuum hose that are each substantially cylindrical. However, other geometries of the exhaust port and vacuum hose (and, therefore, of the first and second openings of the adapter assembly) are envisioned, such as having a substantially rectilinear cross-sectional shape.

Additionally, embodiments of the adapter assembly may be provided in different sizes. Therefore, various components of the adapter assembly may differ dimensionally between embodiments. In general, the adapter assembly may include a tapered tube adapter provided in a size that corresponds to one of a plurality of standard vacuum hose sizes. For example, the tube adapter can be designed to be coupled with a standard vacuum hose having a diameter of about 1.25 inches, about 1.5 inches, about 1.875 inches, and/or about 2.5 inches, among other sizes standard in the art. Alternatively, the tube adapter may be provided in other suitable sizes or shapes. Further, the adapter assembly is compatible with one of a plurality of power tool exhaust port sizes. For example, the adapter assembly may be compatible with an exhaust port having a width or diameter between about 1.25 inches and about 4 inches, although the adapter assembly may also be compatible with exhaust ports having a width or diameter of less than 1.25 inches or greater than 4 inches.

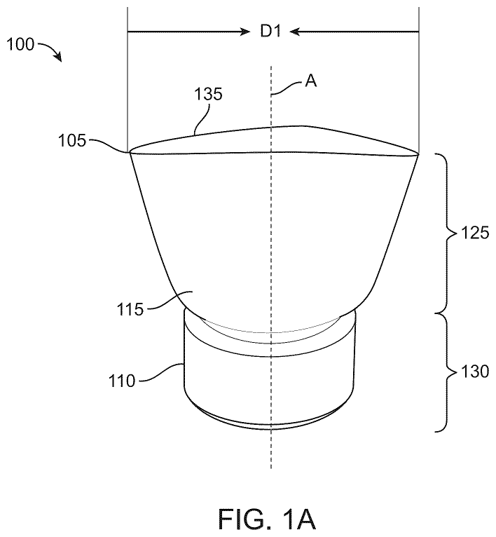

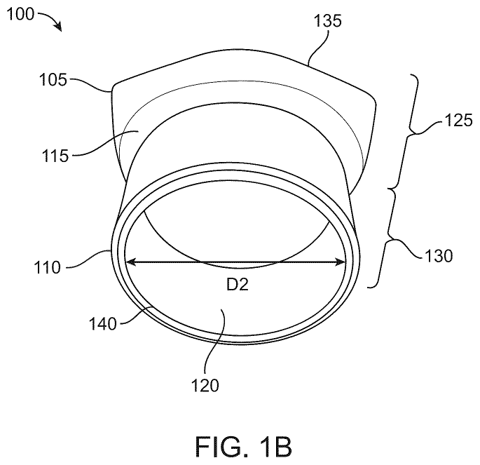

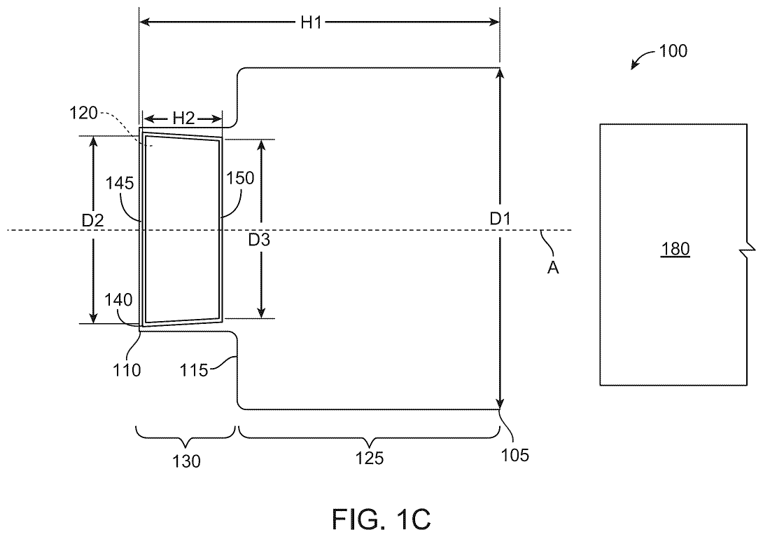

FIGS. 1A-1C illustrate an adapter assembly 100 according to the disclosure. The adapter assembly 100 includes a first end 105 and a second end 110 opposing the first end 105. The adapter assembly 100 can include a heat shrink tube 115 and a tapered tube adapter 120. The heat shrink tube 115 and tapered tube adapter 120 may be substantially coaxial structures in that they may each be formed substantially symmetrically about the same central longitudinal axis A. FIGS. 1A-1C illustrate the adapter assembly 100 prior to installation.

The heat shrink tube 115 may include a first section 125 proximate to the first end 105 of the adapter assembly 100 and a second section 130 proximate to the second end 110 of the adapter assembly 100. The second section 130 of the heat shrink tube 115 may at least partially surround the tapered tube adapter 120 (see FIGS. 1B and 1C). In some instances, the second section 130 of the heat shrink tube 115 may extend over the entire length of the tapered tube adapter 120 such that the second section 130 reaches the entire way or nearly the entire way to the second end 110 of the adapter assembly 100 and fully covers an outside surface of the tapered tube adapter 120. Alternatively, the second section 130 may extend over less than the entire length of the tapered tube adapter 120, thus leaving a portion of the outside surface of the tapered tube adapter 120 exposed. Further, the second section 130 is pre-shrunk around the tapered tube adapter 120 such that an inner surface of the second section 130 is in contact with the outer surface of the tapered tube adapter 120.

It should be noted that the first section 125 of the heat shrink tube 115 will remain substantially unshrunk before the installation process begins, which is described in further detail below. Pre-shrunk means that heat has been applied in advance to the heat shrink tube 115, or a section of heat shrink tube 115, to reduce the diameter of the heat shrink tube 115, or the section of heat shrink tube 115, from the diameter of the heat shrink tube 115 as originally manufactured. Unshrunk means that the heat shrink tube 115, or a section of heat shrink tube 115, has a diameter that is substantially the same as the originally manufactured heat shrink tube 115, and that the heat shrink tube 115, or the section of heat shrink tube 115, is capable of shrinking in diameter upon the application of heat to the heat shrink tube 115, or the section of heat shrink tube 115.

The second section 130 may be secured or coupled to the tapered tube adapter 120 via the friction force between the outer surface of the tapered tube adapter 120 and the inner surface of the heat shrink tube 115. In some forms, the second section 130 is coupled to the tapered tube adapter 120 by an adhesive agent, which may be pre-manufactured on or applied to the inner surface of the heat shrink tube 115, thus lining the inner surface of the heat shrink tube 115. Therefore, the second section 130 of the heat shrink tube 115 may be pre-shrunk so as to be in contact with, and follow the contours of, the outer surface of the tapered tube adapter 120, while also being adhesively coupled to the tapered tube adapter 120.

The first section 125 of the heat shrink tube 115 may be substantially cylindrical or substantially frustoconical in shape. In some instances, an internal diameter of the first section 125 may increase from the portion of the first section 125 proximate to the tapered tube adapter 120 to the portion of the first section 125 proximate to the first end 105 of the adapter assembly 100. At the first end 105, the first section 125 may have a first rim 135 that defines a first opening of the adapter assembly 100. The first rim 135 may have a substantially circular profile. Therefore, the adapter assembly 100 may have a first internal diameter D1 at the first end 105 (see FIG. 1C). The first section 125 of the heat shrink tube 115 is configured to receive a variety of power tool exhaust ports having different sizes. For example, the first section 125 may be configured to receive an exhaust port having a diameter, or widest cross-sectional dimension, between about 1.25 inches and about 4 inches. Additionally, while the first section 125 is illustrated as having a substantially circular profile, the first section 125 may also be provided in any suitable shape.

Likewise, as shown best in FIG. 1B, the tapered tube adapter 120 may have a second rim 140 at the second end 110 of the adapter assembly 100. The second rim 140 may form a second opening of the adapter assembly 100. The second rim 140 may have a substantially circular profile. Therefore, the adapter assembly 100 may have a second internal diameter D2 at the second end 110 (see FIGS. 1B and 1C). The second internal diameter D2 may be smaller than the first internal diameter D1. The tapered tube adapter 120 is configured to receive one of a variety of vacuum hose sizes. Additionally, while the tapered tube adapter 120 is illustrated as having a substantially circular cross-section, the tapered tube adapter 120 may be provided in any suitable shape.

The heat shrink tube 115 may be formed from a heat shrink material designed to contract or shrink in size (e.g., exhibit a decrease in width, diameter, circumference, and/or other dimensions) when exposed to heat. For example, the heat shrink tube 115 may comprise a thermoplastic compound such as polyolefin, fluoropolymers including PTFE, FEP, and PFA, polyvinyl chloride (PVC), neoprene, silicon elastomer, fluoroelastomer (e.g., Viton), polyvinylidene fluoride (PVDF), or any other suitable material. Further, the heat shrink tube 115 may be formed from a material having a relatively high shrink ratio. The heat shrink material can have a shrink ratio of at least about 1.5:1 (e.g., a material that will shrink by up to a factor of 1.5 when heat is applied). Alternatively, the heat shrink material can have a shrink ratio of at least about 2:1, at least about 3:1, at least about 4:1, at least about 5:1, or at least about 6:1. In some instances, the first section 125 of the heat shrink tube 115 may be formed from the same heat shrink material as the second section 130. In other instances, the first section 125 may be formed from a different material than the second section 130.

The tapered tube adapter 120 may be formed from a rigid material, such as a plastic. For example, the tapered tube adapter 120 may be formed from polyethylene, polypropylene, polystyrene, acrylonitrile butadiene styrene (ABS), polycarbonate, polyethylene terephthalate, polyvinyl chloride (PVC), or any other suitable material.

Referring further to FIG. 1C, the tapered tube adapter 120 is configured to receive a vacuum hose 180. It should be noted that the vacuum hose 180 is coupled to and in fluid communication with a vacuum device (not shown). The tapered tube adapter 120 may have a first end 150 and a second end 145, which forms the second rim 140, opposing the first end 150. The second end 145 of the tapered tube adapter 120 may correspond to and substantially align with the second end 110 of the adapter assembly 100. Thus, the second end 145 of the tapered tube adapter 120 defines the second internal diameter D2 of the adapter assembly 100. At the second end 145 of the tapered tube adapter 120, the adapter assembly 100 has a third internal diameter D3. The tapered tube adapter 120 may be imparted with a tapered, frustoconical, or other shape such that the width or diameter of the tapered tube adapter 120 tapers from the second end 145 to the first end 150. For example, the third internal diameter D3 may be smaller than the second internal diameter D2.

This tapered geometry can facilitate a tapered slip fit between the tapered tube adapter 120 and the vacuum hose 180. For example, the second internal diameter D2 forms a slip fit with the vacuum hose 180 such that the vacuum hose 180 can slide into the tapered tube adapter 120 at the second end 145, and the third internal diameter D3 forms a transition fit with the vacuum hose 180 such that the third internal diameter D3 is at least slightly smaller than the outer diameter of the vacuum hose 180 to form a selective coupling when a mild to moderate amount of force is used to push the vacuum hose 180 toward the first end 150.

An exemplary embodiment of the adapter assembly 100 configured for use with a 2.5 inch vacuum hose will now be described with reference to FIG. 1C. However, it is to be understood that the adapter assembly 100 may be provided for use with vacuum hoses of other sizes and the various components of the adapter assembly 100 may have any suitable shape, size, or configuration. In this example, the second opening at the second end 110 of the adapter assembly 100 (and the second end 145 of the tapered tube adapter 120) may be substantially equal (or slightly larger) in size and shape to the end of the vacuum hose 180. For example, the second internal diameter D2 of the adapter assembly 100 may be imparted with a value substantially equal to about 2.5 inches. In this embodiment, the third internal diameter D3 may be imparted with a value of about 2.28 inches, and the first internal diameter D1 may be imparted with a value of about 4 inches. Accordingly, the vacuum hose 180 will slide into the tapered tube adapter 120 at the second end 145 and form a selective coupling with the tapered tube adapter 120 when a mild to moderate amount of force is used to push the vacuum hose 180 toward the first end 150.

Further, the adapter assembly 100 may have an overall height H1. The overall height H1 may be defined by the distance between the first end 105 and the second end 110 of the adapter assembly 100 and may be measured in a direction substantially parallel to the axis A. Similarly, the tapered tube adapter 120 may have a height H2. The height H2 may be defined by the distance between the second end 145 and the first end 150 of the tapered tube adapter 120 and may be measured in a direction substantially parallel to the axis A. In some forms, the adapter assembly 100 may have an overall height H1 of about 4 inches. In some other forms, the overall height H1 may be imparted with a value of at least about 2 inches, at least about 3 inches, at least about 4 inches, at least about 5 inches, or at least about 6 inches. Further, the tapered tube adapter 120 may have a height H2 of about 1.25 inches. In some forms, the height H2 may be imparted with a value of about 0.75 inches to about 2 inches. Various components of the adapter assembly 100 may be provided with different dimensions depending on the application. For example, the dimensions of the tapered tube adapter 120 may be modified depending on the size of the vacuum hose 180.

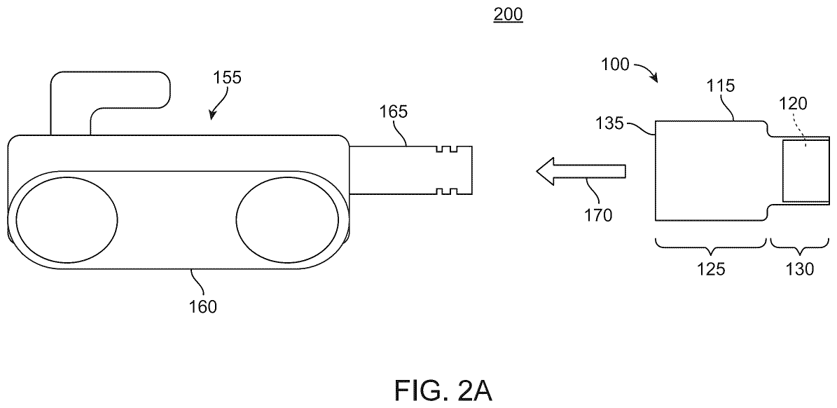

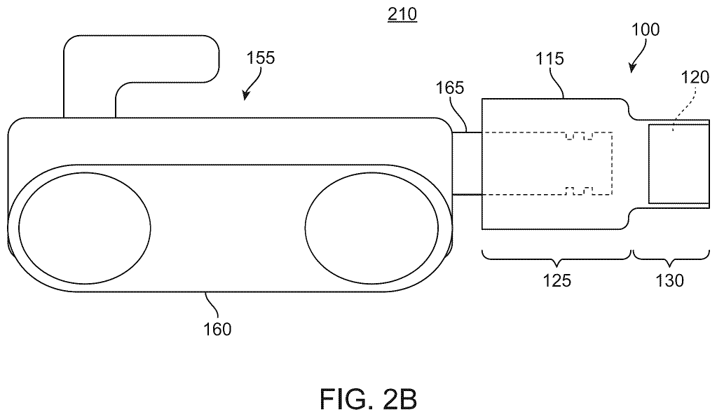

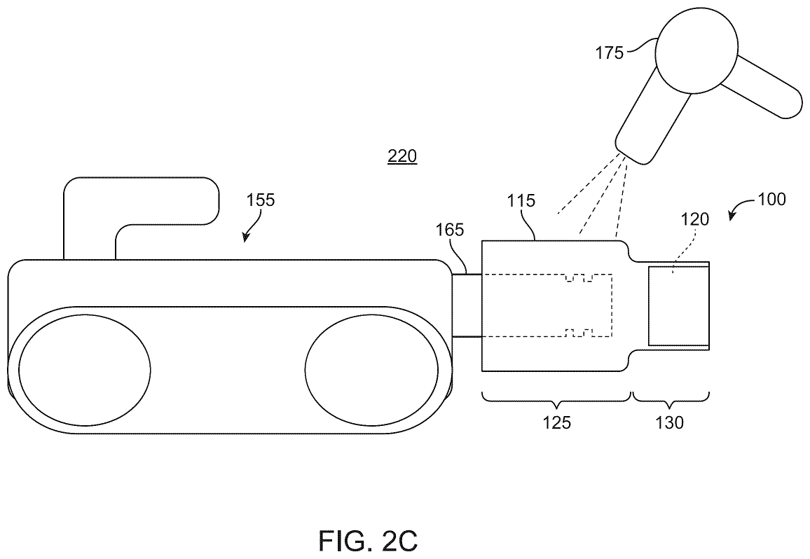

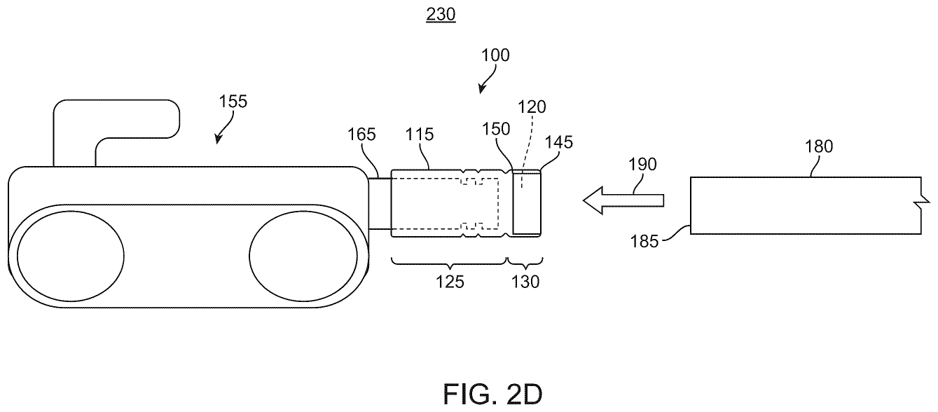

FIGS. 2A-2D illustrate the steps of a method of coupling the vacuum hose 180 to an exhaust port 165 of a power tool 155 using the adapter assembly 100. As shown in FIGS. 2A-2D, the power tool 155 may have, among other components, a body 160 and the exhaust port 165. The exhaust port 165 may be coupled to and extend outwardly from the body 160, or the exhaust port 165 may be formed integrally with the body 160. The exhaust port 165 is configured to eject particulate matter, exhaust fumes, or other materials or byproducts from the power tool 155 while the power tool 155 is in use.

FIG. 2A illustrates step 200, wherein the first opening of the adapter assembly 100 defined by the first rim 135 is aligned with the exhaust port 165. The adapter assembly 100 is then moved toward the exhaust port 165 in the direction indicated by arrow 170 in FIG. 2A. FIG. 2B illustrates step 210, wherein the exhaust port 165 is at least partially received within the heat shrink tube 115 such that the first section 125 of the heat shrink tube 115 at least partially surrounds the exhaust port 165.

FIG. 2C illustrates step 220, wherein a heating device 175 is used to apply heat to the first section 125 of the heat shrink tube 115 while the heat shrink tube 115 is at least partially surrounding the exhaust port 165. The heating device 175 may be a heat gun, blow dryer, heat lamp, or any other suitable device capable of applying localized heat to an object. The heat from the heating device 175 causes the heat shrink material of the first section 125 to shrink around the exhaust port 165. In other words, the diameter/circumference of the first section 125 will decrease in response to the application of heat from the heating device 175. Heat is applied to the first section 125 at least until the first section 125 shrinks enough to come into contact with the outer surface of the exhaust port 165. In this way, the heating device 175 may cause the first section 125 to be securely fitted to the exhaust port 165, as shown in FIG. 2D.

In embodiments where the heat shrink tube 115 includes adhesive at least partially lining the inner surface, the inner surface of the heat shrink tube 115 will become adhered to the exhaust port 165. Thus, the first section 125 of the heat shrink tube 115 will follow the contours of the outer surface of the exhaust port 165, while also being adhesively coupled to the exhaust port 165. In some forms, the heat shrink tube 115 does not include an adhesive partially lining the inner surface. In this instance, the first section 125 is secured or coupled to the exhaust port 165 via the friction force between the outer surface of the exhaust port 165 and the inner surface of the heat shrink tube 115. Alternatively, adhesive can be applied to the outer surface of the exhaust port 165 prior to step 210.

Once the adapter assembly 100 is installed on the exhaust port 165, the vacuum hose 180 may be selectively coupled with the tapered tube adapter 120 in step 230, as shown in FIG. 2D. For example, with the adapter assembly 100 installed and securely coupled to the exhaust port 165, the user may align a first end 185 of the vacuum hose 180 with the second opening of the adapter assembly 100 (i.e., the second end 145 of the tapered tube adapter 120). The first end 185 of the vacuum hose 180 can then be moved toward the tapered tube adapter 120 in the direction of the arrow 190. The vacuum hose 180 can be pushed into the tapered tube adapter 120 until the first end 185 of the vacuum hose 180 approaches or reaches the first end 150 of the tapered tube adapter 120. The tapered geometry of the tapered tube adapter 120 provides a secure connection between the tapered tube adapter 120 and the vacuum hose 180 such that the vacuum hose 180 is held securely in place within the tapered tube adapter 120. In some instances, before coupling the vacuum hose 180 to the tapered tube adapter 120, it may be advantageous to allow the adapter assembly 100 time to cool due to the application of heat to the heat shrink tube 115 in step 220. In other instances, the adapter assembly 100 may be installed without allowing time for cooling.

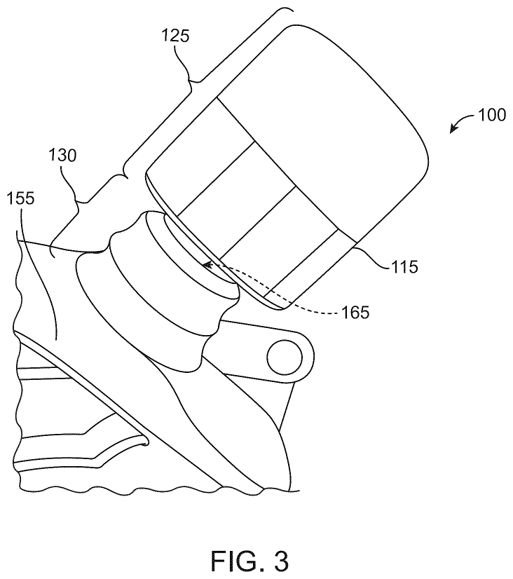

FIG. 3 illustrates the adapter assembly 100 after installation of the adapter assembly 100 onto the exhaust port 165 of a power tool 155 in step 220 but prior to coupling the adapter assembly 100 to the vacuum hose 180 in step 230. As shown, the first section 125 of the heat shrink tube 115 may “hug” or be tightly fitted to the exhaust port 165 after application of heat from the heating device 175. Thus, the adapter assembly 100 may be coupled to and extend outwardly away from the exhaust port 165.

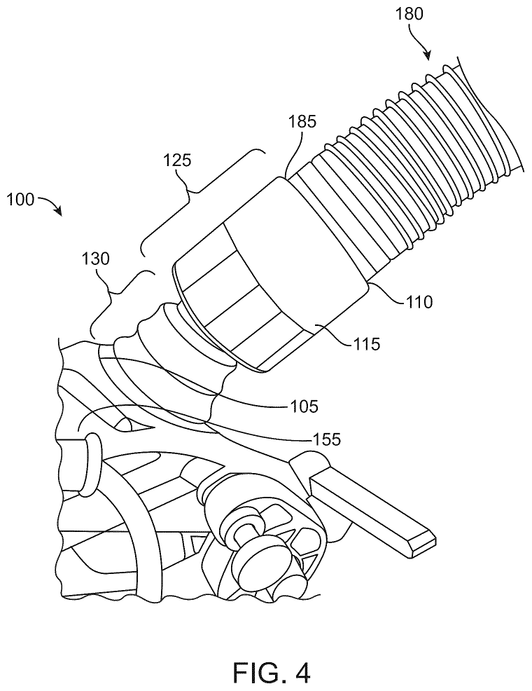

FIG. 4 illustrates the adapter assembly 100 after step 230 is complete, i.e., after the first end 105 has been coupled to the exhaust port 165 of a power tool 155 and the second end 110 has been coupled to the vacuum hose 180. As shown, the first end 185 of the vacuum hose 180 has been inserted into and securely fitted within the tapered tube adapter 120. At this stage, the adapter assembly 100 provides a substantially air-tight connection between the exhaust port 165 and the vacuum hose 180. Thus, the power tool 155 may be powered on and used, and any harmful particulate matter ejected by the power tool 155 via the exhaust port 165 during use will be collected by the vacuum device through the vacuum hose 180.

The adapter assembly 100 effectively seals an air flow path between the power tool 155 and the vacuum hose 180 such that harmful particulate matter may be prevented from entering the surrounding environment. Therefore, the adapter assembly 100 protects the users of the power tool 155 from, for example, inhaling harmful particulate matter generated by the power tool 155 during use. Because the adapter assembly 100 can be provided in a variety of sizes and shapes, as described above, a power tool user can install various adapter assemblies 100 onto one or more power tools 155 in a workshop space. Accordingly, once each of the adapter assemblies 100 is installed, the users of the power tools 155 can quickly and easily couple (and decouple) the vacuum hose 180 to the exhaust ports 165 of different power tools 155 before the user activates a certain power tool 155, allowing for the safe collection of particulate matter.

Thus, an improved adapter assembly for a power tool is provided. In other embodiments, other configurations are possible. It should be known that this disclosure contemplates various combinations, sub-combinations, and substitutions of the components discussed above.

1. An adapter assembly comprising:
a tapered tube adapter configured to couple to a vacuum hose; and
a heat shrink tube formed from a heat shrink material and coupled to the tapered tube adapter,
wherein the tapered tube adapter is configured to receive the vacuum hose, and
wherein the heat shrink tube is configured to be coupled to an exhaust port of a power tool.

2. The adapter assembly of claim 1, wherein the heat shrink tube includes a first section configured to be coupled to the exhaust port and a second section coupled to the tapered tube adapter.

3. The adapter assembly of claim 2, wherein the second section is pre-shrunk around the tapered tube adapter.

4. The adapter assembly of claim 2, wherein the first section shrinks in response to an application of heat.

5. The adapter assembly of claim 2, wherein the second section is coupled to the tapered tube adapter by an adhesive.

6. The adapter assembly of claim 1, wherein the tapered tube adapter includes a first end and a second end, wherein the tapered tube adapter is defined by a first diameter at the first end and a second diameter at the second end, and wherein the first diameter is larger than the second diameter.

7. The adapter assembly of claim 1, wherein the tapered tube adapter is configured to receive the vacuum hose in a slip fit.

8. The adapter assembly of claim 2, wherein the first section has a larger diameter than the second section.

9. The adapter assembly of claim 1, wherein the heat shrink tube is configured to be interchangeably coupled to a plurality of power tools, the exhaust port of each power tool having a unique diameter dimension.

10. An adapter assembly comprising:
a heat shrink tube defined by a first end and a second end;
a first opening positioned proximate to the first end; and
a tapered tube adapter positioned proximate to the second end and at least partially received within the heat shrink tube,
wherein the first opening is configured to receive an exhaust port of a power tool, and the tapered tube adapter is configured to receive a vacuum hose.

11. The adapter assembly of claim 10, wherein the heat shrink tube is formed from a heat shrink material that shrinks in response to an application of heat.

12. The adapter assembly of claim 11, wherein the heat shrink tube includes an unshrunk first section proximate to the first end and a pre-shrunk second section proximate to the second end, the second section being coupled to the tapered tube adapter.

13. The adapter assembly of claim 12, wherein the second section includes an adhesive that facilitates coupling between the heat shrink tube and the tapered tube adapter.

14. The adapter assembly of claim 10, wherein the tapered tube adapter includes an adapter first end proximate to the second end of the heat shrink tube and an adapter second end opposing the adapter first end, wherein the tapered tube adapter is defined by a first diameter at the adapter first end and a second diameter at the adapter second end, and wherein the first diameter is larger than the second diameter.

15. The adapter assembly of claim 14, wherein the tapered tube adapter is positioned to extend into the heat shrink tube from the second end of the heat shrink tube.

16. The adapter assembly of claim 10, wherein the tapered tube adapter is configured to receive the vacuum hose in a slip fit.

17. The adapter assembly of claim 10, wherein the tapered tube adapter defines a second opening configured to receive the vacuum hose.

18. A method of installing a vacuum adapter assembly comprising:
providing an adapter assembly having a tapered tube adapter and a heat shrink tube, the heat shrink tube including:
an adhesive at least partially lining an inner surface of the heat shrink tube,
a first section, and
a second section, the second section at least partially surrounding the tapered tube adapter and in contact with an outer surface of the tapered tube adapter;
covering an exhaust port of a power tool with the first section of the heat shrink tube;
applying heat to the first section at least until the inner surface of the heat shrink tube is in contact with the exhaust port; and
coupling the tapered tube adapter to a vacuum hose.

19. The method of claim 18, wherein the tapered tube adapter receives the vacuum hose in a slip fit.

20. The method of claim 18, wherein the first section of the heat shrink tube is configured to receive a plurality of different exhaust ports having different sizes.
